(19) United States
(12) Patent Application Publication
(10) Pub. No.: US 2005/0252476 A1
(43) Pub. Date: Nov. 17, 2005

(54) Mounting structure for resonator

(76) Inventor: Norito Inoue, Toyota-shi (JP)

Correspondence Address: KENYON & KENYON, 1500 K STREET NW, SUITE 700, WASHINGTON, DC, 20005, US

(21) Appl. No.: 11/107,790

(22) Filed: Apr. 18, 2005

(30) Foreign Application Priority Data
May 12, 2004 (JP) 2004-142745

(51) Int. Cl. F02M 35/10

(52) U.S. Cl. 123/184.57

(57) ABSTRACT

An upper bracket having a hook receiving hole is provided in an upper portion of the interior of the fender. A lower bracket having a nut is provided in a lower portion of the fender. A resonator has a pin and a bolt receiving portion. The pin has an elastic hook portion that is hooked to and supported by the upper bracket. The bolt receiving portion is fixed to the nut of the lower bracket with a bolt. The pin is inserted into the hook receiving hole so that the resonator is positioned in a hooked state. Then, the resonator is mounted in the fender by performing screwing procedure.

### BACKGROUND OF THE INVENTION

The present invention relates to a structure for mounting a resonator in a fender of an automobile.

Typically, a resonator is attached to an intake duct of an automobile engine to reduce intake noise. Conventionally, a resonator is mounted in an engine compartment or in a fender together with an intake duct. For example, Japanese Laid-Open Patent Publication No. 6-200847 discloses a resonator mounted in a fender. This resonator is advantageous in lowering the temperature of intake air.

FIG. 7 is a perspective view illustrating a mounting structure of a resonator disclosed in Japanese Laid-Open Patent Publication No. 6-200847. As shown in FIG. 7, two shoulder bolts 52 are integrated with a resonator 51 by insert molding. The head of each shoulder bolt 52 is embedded in the resonator 51. Two bolt receiving holes 54 are formed in a side panel 53 that separates the interior of the fender from the engine compartment. A shaft of each bolt 52 is inserted into one of the bolt receiving holes 54 toward the engine compartment. A thread of each bolt 52 protrudes into the engine compartment. A nut 55 is screwed onto the thread of each bolt 52 with a rubber cushion 56. In this way, the resonator 51 is mounted in the fender.

However, the conventional mounting structure for the resonator 51 has the following drawbacks. That is, when mounting the resonator 51 in the fender together with an intake duct, a worker supports the resonator 51 with one hand and inserts it into the fender from below such that the shafts of the bolts 52 are inserted into the bolt receiving holes 54 of the side panel 53. At the same time, the worker has to screw the nuts 55 onto the threads of the bolts 52 with the other hand. That is, positioning of the resonator 51 and screwing of the nuts 55 need to be performed simultaneously in the confined fender. This reduces the workability.

### SUMMARY OF THE INVENTION

Accordingly, it is an objective of the present invention to provide a mounting structure of a resonator that permits a resonator to be quickly and easily mounted in a confined fender.

To achieve the foregoing and other objectives and in accordance with the purpose of the present invention, a mounting structure of a resonator for mounting a resonator in a fender of a vehicle body is provided. The mounting structure includes a first mounting member and a second mounting member. The first mounting member is capable of hooking the resonator to the vehicle body. The second mounting member fixes the resonator to the vehicle body with a screw.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view illustrating a mounting structure of a resonator according to one embodiment;

FIG. 2 is a cross-sectional view taken along line 2-2 in FIG. 1;

FIG. 3 is an exploded perspective view illustrating the mounting structure for the resonator;

FIG. 4 is an enlarged front view illustrating a pin forming an anchor portion;

FIGS. 5(a) to 5(d) are diagrams for explaining deformation of an elastic hook portion when the pin is engaged with a pin receiving hole;

FIG. 6 is a diagram showing a first mounting member according to another embodiment; and

FIG. 7 is a perspective view illustrating a prior art mounting structure of a resonator.

### DETAILED DESCRIPTION OF THE PREFERRED EMBODIMENTS

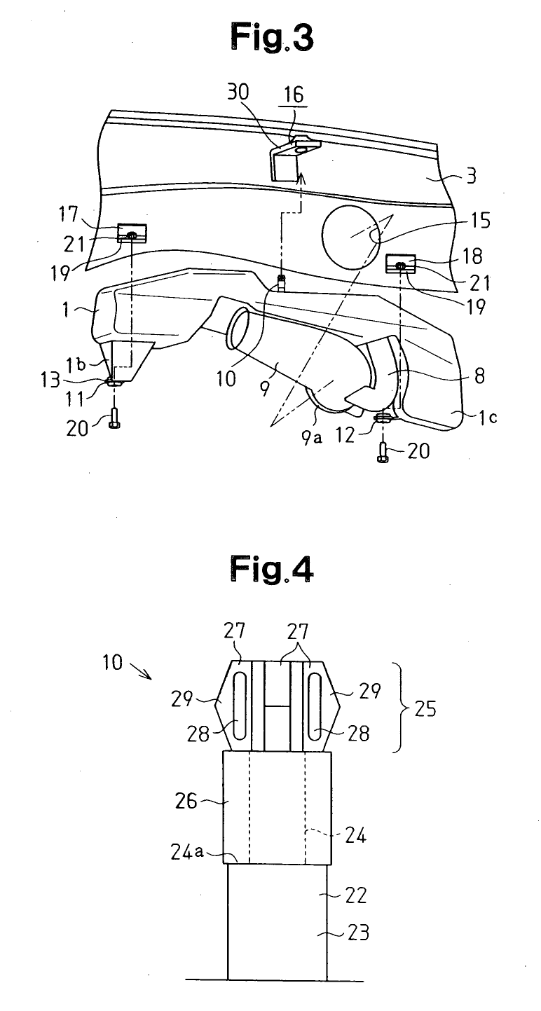

A mounting structure of a resonator in an automobile fender according to one embodiment of the present invention will now be described with reference to FIGS. 1 to 5(d).

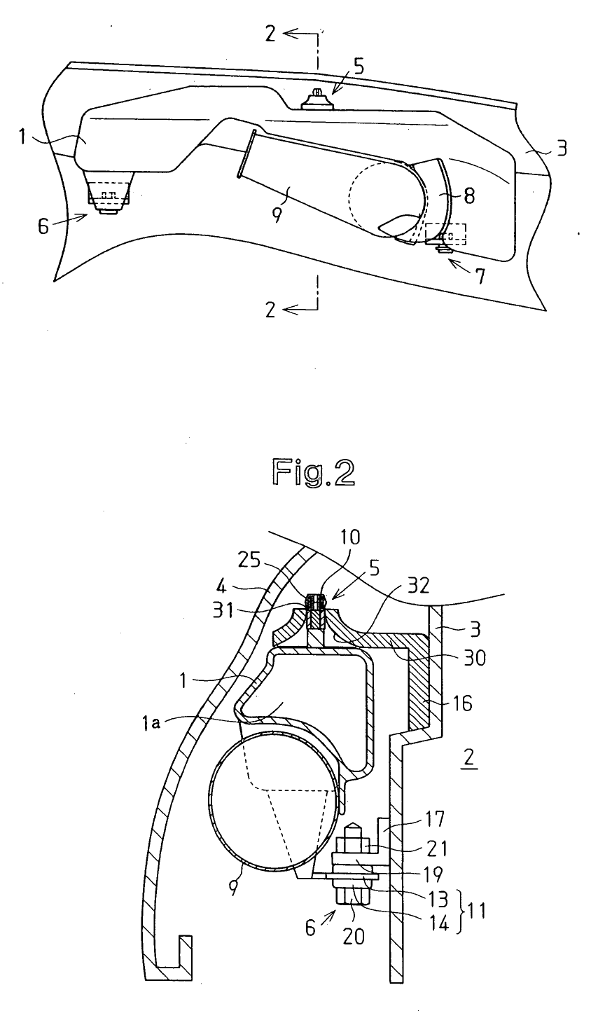

A resonator 1 of the present embodiment functions as an intake muffler device. As shown in FIGS. 1 and 2, the resonator 1 is located in a fender 4. Specifically, the fender 4 is attached to an apron panel 3, which is a sidewall of an engine compartment 2. The fender 4 extends diagonally downward like a canopy. In the fender 4, the resonator 1 is attached to the apron panel 3 of the vehicle body with a plurality of mounting members 5, 6, 7, the number of which is three in this embodiment. In the present embodiment, the mounting member 5, which is referred to as a first mounting member, and the mounting members 6, 7, which are referred to as second mounting members, form the mounting structure for the resonator 1. The first mounting member 5 is engaged with and supports the resonator 1 in an upper portion of the interior of the fender 4. The second mounting members 6, 7 fix the resonator 1 in a lower portion of the interior of the fender 4 with screws.

As shown in FIGS. 1 to 3, the resonator 1 is a horizontally extending resin box having an irregular shape. A hollow la is defined in the resonator 1. The resonator 1 is formed integrally with an intake duct 9 with a communication pipe 8. In a center portion of the upper surface of the resonator 1 with respect to a longitudinal direction, a pin 10 is provided to extend upward. The pin 10 is located at a position that corresponds to the center of gravity of the resonator 1. The pin 10 is a component of the first mounting member 5 on the side of the resonator 1.

Bulge portions 1b, 1c are formed at both ends of the resonator 1 with respect to the longitudinal direction by bulging sections of the resonator 1. On the lower surfaces of the bulge portions 1b, 1c, bolt receiving portions 11, 12 are provided, respectively. The bolt receiving portions 11, 12 are components of the second mounting members 6, 7 on the side of the resonator 1. Each of the bolt receiving portions 11, 12 includes an arm 13 and a rubber grommet 14. The arms 13 extend laterally from the bulge portions 1b, 1c of the resonator 1. The grommet 14 is fitted in a hole formed in a distal end of the arm 13.

On the other hand, a duct hole 15 is formed in the apron panel 3. An open end 9a of the intake duct 9, which is mounted in the fender 4 together with the resonator 1, is connected to the duct hole 15. The open end 9a is connected to an air cleaner. An L-shaped upper bracket L is attached to an upper inner surface of the apron panel 3 in an upper portion of the interior of the fender 4. The upper bracket 16 is a component of the first mounting member 5 that is located on the side of the apron panel 3 (on the side of the vehicle body). The upper bracket 16 functions as an anchor receiving portion.

At positions lower than the upper bracket 16, L-shaped lower brackets 17, 18 are attached to the apron panel 3. The lower brackets 17, 18 correspond to the bolt receiving portions 11, 12, respectively. Each of the lower brackets 17, 18 is a component of the corresponding one of the second mounting members 6, 7 that is located on the side of the apron panel 3 (on the side of the vehicle body).

A coupler portion 19 of each of the lower brackets 17, 18 has a hole (not shown) for receiving a bolt 20 from below when the resonator 1 is installed. The coupler portion 19 also has a nut 21 that is welded to the coupler portion 19 such that the axis of the nut 21 coincides with the axis of the bolt receiving hole. When the resonator 1 is mounted in the fender 4, the bolt receiving portions 11, 12 of the resonator 1 are brought into contact with the coupler portions 19 of the lower brackets 17, 18 from below as shown in FIG. 2. In this state, the bolts 20 are screwed into the nuts 21 from below, so that the bolt receiving portions 11, 12 are fastened to the lower brackets 17, 18, respectively.

Next, the pin 10 (anchor portion), which is a component of the first mounting member 5, and the upper bracket 16 (anchor receiving portion) will be described.

As shown in FIG. 4, the pin 10 has a shaft portion 22. The proximal end of the shaft portion 22 is integrated with the resonator 1 through insert molding. The shaft portion 22 includes a large diameter portion 23, which extends from the center to the proximal end, and a small diameter portion 24, which extends from the center to the distal end. An elastic hook portion 25 is located at the distal end of the small diameter portion 24. A step plane 24a is defined between the large diameter portion 23 and the small diameter portion 24. A rubber pipe 26 is fitted about the small diameter portion 24. The rubber pipe 26 is located between the step plane 24a and the elastic hook portion 25. The rubber pipe 26 functions as a shock absorbing member for curbing transmission of micro-vibrations due to suction pulsation of the intake duct 9 to the apron panel 3 of the vehicle body through the upper bracket 16.

The elastic hook portion 25 includes a plurality of elastic pieces 27, the number of which is four in this embodiment. The elastic pieces 27 radially project from the outer circumferential surface of the distal portion of the small diameter portion 24 and are arranged at equal angular intervals (90 degrees in this embodiment). Each elastic piece 27 has a slit 28 extending along a longitudinal direction of the shaft portion 22. A portion located outward of the slit 28 forms a V-shaped overhanging section 29. When receiving inward pressing force, the overhanging section 29 of each elastic piece 27 is elastically deformed with the slit 28 crushed.

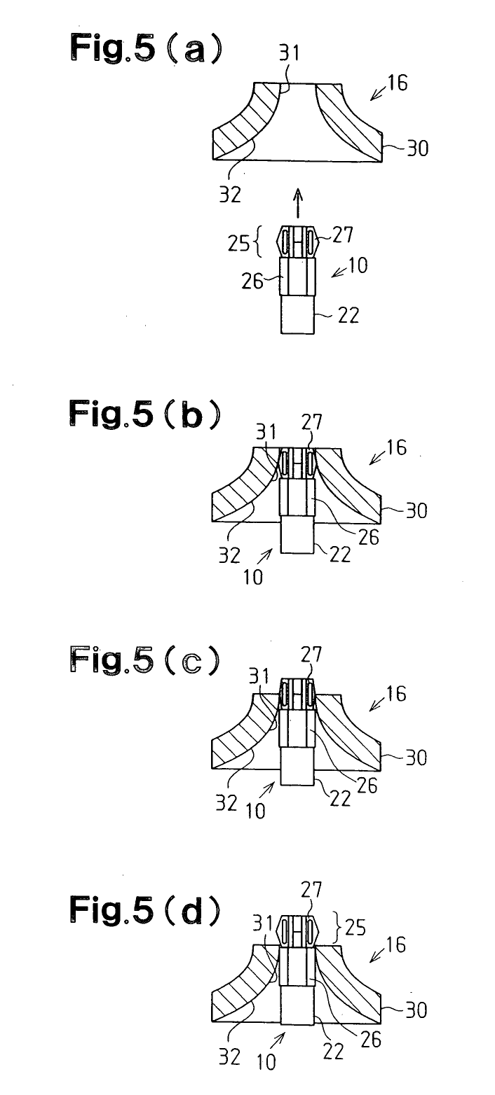

On the other hand, a hook receiving hole 31 (anchor receiving hole) is formed in a coupler portion 30 of the upper bracket 16 as shown in FIGS. 2 and 5(a) to 5(d). When mounting the resonator 1, the pin 10 is inserted into the hook receiving hole 31 from below while deforming the elastic hook portion 25. Then, the elastic hook portion 25 restores the original shape to be hooked to the hook receiving hole 31. A tapered portion 32 is formed about the hook receiving hole 31 on the lower surface of the coupler portion 30. The tapered portion 32 is shaped like a horn. When the elastic hook portion 25 contacts the lower surface of the coupler portion 30 for installing the resonator 1, the tapered portion 32 functions as a guide portion to guide the elastic hook portion 25 to the hook receiving hole 31.

The mounting structure of the resonator 1 configured as above will now be described by mainly focusing on the procedure for mounting the resonator 1 in the fender 4.

First, a worker holds the resonator 1 with a hand and inserts the resonator 1 upward into the fender 4 from below. Then, as shown in FIG. 5(a), in the upper portion of the interior of the fender 4, the pin 10 of the resonator 1 approaches the hook receiving hole 31 of the upper bracket 16 of the apron panel 3 from below. At this time, since the interior of the fender 4 is confined and the mounting operation is performed from below, the hook receiving hole 31 of the position of the upper bracket 16 cannot be visually confirmed. However, in the present embodiment, the tapered portion 32 that functions as a guide portion is formed about the hook receiving hole 31 of the upper bracket 16. Therefore, once the pin 10 is brought into contact with the lower surface of the coupler portion 30 of the upper bracket 16, the tapered portion 32 functions as the guide member and reliably guides the elastic hook portion 25 at the distal end of the pin 10 to the hook receiving hole 31 as shown in FIG. 5(b).

Next, the resonator 1 is lifted so that engagement of the resonator 1 and the tapered portion 32 causes the overhanging sections 29 of the elastic pieces 27 to be deformed inward against the own elasticity. Accordingly, the hook portion 25 at the distal end of the pin 10 passes through the hook receiving hole 31. At the same time as the elastic pieces 27 of the elastic hook portion 25 pass through the hook receiving hole 31, the overhanging sections 29 restore the original shape by the own elasticity. As shown in FIG. 5(d), the overhanging sections 29 are hooked at the edge of the hook receiving hole 31.

In this manner, the resonator 1 of the present embodiment is inserted into the fender 4 and moved in one direction, or lifted, so that the pin 10 (anchor portion) of the resonator 1 is hooked to the upper bracket 16 (anchor receiving portion) of the apron panel 3 in the upper portion of the interior of the fender 4. That is, the resonator 1 is hooked to the first mounting member 5 including the pin 10 and the upper bracket 16 while being positioned relative to the apron panel 3 (the vehicle body). In the hooked state, part of the rubber pipe 26 fitted about the small diameter portion 24 of the pin 10 is fitted in the hook receiving hole 31 as shown in FIG. 5(d).

In the present embodiment, the interior of the fender 4, in which the resonator 1 is mounted, is a vertically elongated confined space with the closed top. Thus, the resonator 1 must be inserted from below. Therefore, unlike the case where the resonator 1 is mounted in the engine compartment 2 after opening an engine hood (not shown), the mounting of the resonator 1 in the fender 4 is considerably troublesome. However, in the present embodiment, when the resonator 1 is inserted into the fender 4 from below, the resonator 1 is hooked to and supported by the first mounting member 5 in the upper portion of the interior of the fender 4, where operations by a hand of a worker or tools are difficult. The worker thus does not have to put a hand into the upper portion of the interior of the fender 4, but only needs to lift the resonator 1 inserted into the fender 4 to provisionally fix the resonator 1 in the fender 4. The worker then proceeds to a procedure for screwing the bolts 20.

On the other hand, in a lower portion of the interior of the fender 4, when the pin 10 is hooked to the upper bracket 16 in the fender 4, the bolt receiving portions 11, 12 of the resonator 1 contact the coupler portions 19 of the lower brackets 17, 18 of the apron panel 3 from below. In this state, since the resonator 1 is held by the first mounting member 5 even if the worker releases the resonator 1, the worker can perform screwing procedure with both hands. Accordingly, the worker inserts and screws the bolts 20 to the nuts 21 of the lower brackets 17, 18 from below.

Then, the resonator 1, which has been in a hooked state with the first mounting member 5, or a provisionally fixed state, is fixed with the intake duct 9 coupled with the hole 15 of the apron panel 3 through the screwing procedure.

When removing the resonator 1 from the apron panel 3 for doing maintenance of the intake system, the second mounting members 6, 7 are first unscrewed. Then, the resonator 1 is pulled downward so that the elastic hook portion 25 of the pin 10 is elastically deformed as in the mounting procedure. The elastic hook portion 25 is thus pulled out of the hook receiving hole 31, and thus unhooked.

The mounting structure for the resonator 1 according to the above embodiment has the following advantages.

(1) The first mounting member 5, which includes the pin 10 of the resonator 1 and the upper bracket 16 of the apron panel 3, permits the resonator 1 to be positioned and hooked in the fender 4. Thereafter, with both hands, the worker can perform the screwing procedure to fix the second mounting members 6, 7. Therefore, the positioning of the resonator 1 in the fender 4 and the screwing of the resonator 1 are separately performed. This permits the troublesome screwing procedure to be easily and quickly performed with both hands, thus significantly improves the workability.

(2) Prior to the screwing procedure, the position of the resonator 1 in the fender 4 is easily determined with the first mounting member 5 simply by moving the resonator 1 into the fender 4 in the predetermined direction, or upward from below. Particularly, since the interior of the fender is a vertically elongated and confined space, the forward and rearward movements and leftward and rightward movements of the resonator 1 are limited. In the present embodiment, since the resonator 1 is moved only in one direction, or upward from below, the resonator 1 is easily positioned in the fender 4.

(3) In the present embodiment, the first mounting member 5 including the pin 10 and the upper bracket 16 is located in the confined upper portion of the interior of the fender 4. Therefore, the screwing procedure does not need to be performed in a position where a hand of a worker or a tool cannot be easily inserted. The mounting of the resonator 1 is thus facilitated.

(4) The elastic hook portion 25 having the elastic pieces 27 is formed at the distal end of the shaft portion 22 of the pin 10. When the pin 10 is inserted into the hook receiving hole 31, the elastic hook portion 25 (elastic pieces 27) is elastically deformed so that the resonator 1 is hooked to and supported by the first mounting member 5. Therefore, the resonator 1 is hooked and supported in the fender 4 by simply inserting the pin 10 into the hook receiving hole 31 of the upper bracket 16.

(5) Each elastic piece 27 has the overhanging section 29 that projects outward, and the upper half and the lower half of each overhanging section 29 are inclined in opposite directions. When the pin 10 is hooked, the lower half of each overhanging section 29 is engaged with the edge of the hook receiving hole 31. Therefore, the resonator 1 is easily detached by pulling the pin 10 downward for doing maintenance.

(6) The rubber pipe 26, which functions as a shock absorbing member, is fitted about the shaft portion 22 of the pin 10 that is inserted into the hook receiving hole 31 of the upper bracket 16. The rubber pipe 26 absorbs micro-vibrations from the intake duct 9. Therefore, transmission of the micro-vibrations from the intake duct 9 to the vehicle body is curbed.

(7) The hook receiving hole 31 of the upper bracket 16 has the tapered portion 32, which functions as a guide portion for guiding the distal end of the pin 10 to the hook receiving hole 31. Therefore, the pin 10 is easily guided to the hook receiving hole 31 in the confined fender.

It should be apparent to those skilled in the art that the present invention may be embodied in many other specific forms without departing from the spirit or scope of the invention. Particularly, it should be understood that the invention may be embodied in the following forms.

The first mounting member 5, which includes the pin 10 and the upper bracket 16, may include an anchor portion and an anchor receiving portion each having a hook-shaped distal end to be engaged with the other hook-shaped distal end. In this case, as in the above illustrated embodiment, the resonator 1 is hooked and supported.

The anchor portion of the first mounting member 5 does not need to be the pin 10 having the elastic hook portion 25, but may be a hook bracket that has a hook at the distal end to be hooked to the hook receiving hole 31 of the upper bracket (anchor receiving portion) 16.

The numbers of the first mounting member 5 and the second mounting members 6, 7 may be changed as necessary, and not limited to the number in the illustrated embodiment (three). For example, to stably hook and support the resonator 1, two or more first mounting members 5 may be provided.

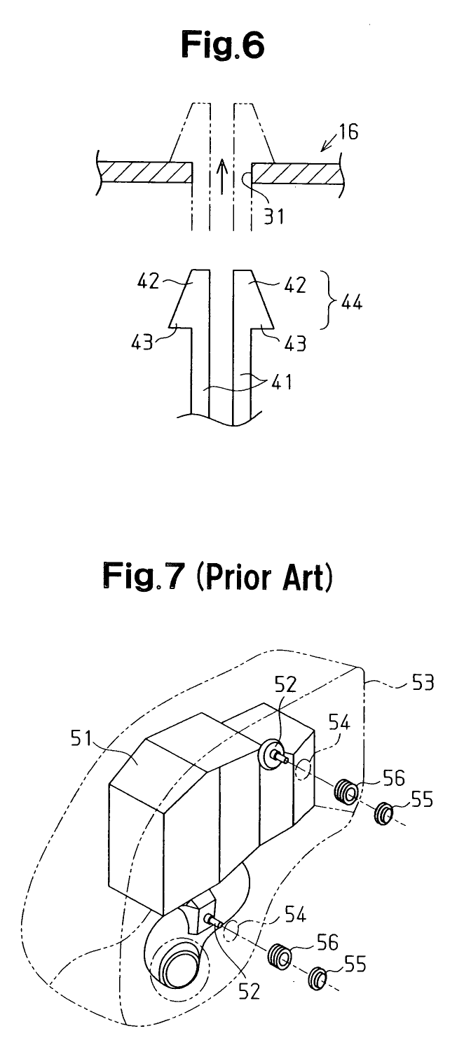

The elastic pieces 27 may be replaced by two elastic shafts 41 shown in FIG. 6. As shown in FIG. 6, an elastic piece 42 is provided at the distal end of each elastic shaft 41, and each elastic piece 42 has a hook 43. The hooks 43 are engaged with the upper bracket 16 to prevent the elastic shafts 41 from being moved downward. The elastic shafts 41 and the hooks 43 form an elastic hook portion 44. When passing through the hook receiving hole 31 of the upper bracket 16, the elastic shafts 41 are elastically deformed so that the elastic pieces 42 of the elastic hook portion 44 approach each other. After the elastic shafts 41 pass through the hook receiving hole 31, the hooks 43 of the elastic pieces 42 are engaged with the edge of the hook receiving hole 31. Therefore, like the above illustrated embodiment, the elastic hook portion 44 functions as a anchor portion.

The shape of the hook receiving hole 31 is not limited to the illustrated ones. That is, whatever the shape is, the hook receiving hole 31 functions as an anchor receiving portion as long as the hook receiving hole 31 has a space that corresponds to the elastic hook portion 25 of the pin 10, and the elastic hook portion 25 can be engaged with the hole 31 after being passed through the hole 31.

The pin 10 does not need to be located at the longitudinal center of the resonator 1, which corresponds to the center of gravity of the resonator, but may be located at any position on the upper surface of the resonator 1.

A block type shock absorbing member made of foam, for example, of ethylene propylene diene monomer (EPDM), may be located between the resonator 1 and the apron panel 3. Compared to the case where the rubber pipe 26 that functions as a shock absorbing member is fitted only about the shaft portion 22 of the pin 10, transmission of micro-vibrations from the intake duct 9 to the vehicle body is more effectively curbed. In this case, the rubber pipe 26 does not need to be fitted about the shaft portion 22 of the pin 10.

Therefore, the present examples and embodiments are to be considered as illustrative and not restrictive and the invention is not to be limited to the details given herein, but may be modified within the scope and equivalence of the appended claims.

1. A mounting structure of a resonator for mounting a resonator in a fender of a vehicle body, comprising:
a first mounting member that is capable of hooking the resonator to the vehicle body; and
a second mounting member that fixes the resonator to the vehicle body with a screw.

2. The mounting structure of a resonator according to claim 1, wherein the first mounting member includes an anchor receiving portion provided in one of the vehicle body and the resonator, and an anchor portion provided in the other one of the vehicle body and the resonator, and wherein, when the resonator is moved in a predetermined single direction in the fender, the anchor portion is hooked to the anchor receiving portion.

3. The mounting structure of a resonator according to claim 2,
wherein the anchor receiving portion has an anchor receiving hole, and
wherein the anchor portion includes a shaft portion that is insertable into the anchor receiving hole, an elastic hook portion being formed on the shaft portion, wherein the elastic hook portion is elastically deformed to be hooked to the anchor receiving hole.

4. The mounting structure of a resonator according to claim 3, wherein the anchor receiving portion is located in an upper portion of the interior of the fender in the vehicle body, wherein the shaft portion is permitted to be passed through the anchor receiving hole from below, and wherein the shaft portion of the anchor portion projects upward from an upper surface of the resonator.

5. The mounting structure of a resonator according to claim 3, wherein the anchor receiving portion has a guide portion that guides a distal end of the shaft portion of the anchor portion to the anchor receiving hole.

6. The mounting structure according to claim 2, wherein a shock absorbing member is located between the anchor portion and the anchor receiving portion.

7. A mounting structure of a resonator for mounting a resonator in a fender of a vehicle body, comprising:
a first mounting member capable of hooking and supporting the resonator to the vehicle body, wherein the first mounting member includes an anchor receiving portion provided in the vehicle body and an anchor portion provided in the resonator, and wherein, when the resonator is moved in a predetermined single direction in the fender, the anchor portion is hooked to the anchor receiving portion; and
a second mounting member that fixes the resonator to the vehicle body with a screw, wherein the second mounting member includes a pair of brackets attached to the vehicle body with a predetermined space in between, a pair of arms extending from the resonator, each arm corresponding to one of the brackets, and fixtures, each fixture corresponding to and fixing one of the brackets and the arms.

8. The mounting structure of a resonator according to claim 7,
wherein the anchor receiving portion has an anchor receiving hole, and
wherein the anchor portion includes a shaft portion that is insertable into the anchor receiving hole, an elastic hook portion being formed on the shaft portion, wherein the elastic hook portion is elastically deformed to be hooked to the anchor receiving hole.

9. The mounting structure of a resonator according to claim 8, wherein the anchor receiving portion is located in an upper portion of the interior of the fender in the vehicle body, wherein the shaft portion is permitted to be passed through the anchor receiving hole from below, and wherein the shaft portion of the anchor portion projects upward from an upper surface of the resonator.

10. The mounting structure of a resonator according to claim 8, wherein the anchor receiving portion has a guide portion that guides a distal end of the shaft portion of the anchor portion to the anchor receiving hole.

11. The mounting structure according to any one of claim 7, wherein a shock absorbing member is located between the anchor portion and the anchor receiving portion.
